(19) United States
(12) Patent Application Publication
(10) Pub. No.: US 2005/0148227 A1
(43) Pub. Date: Jul. 7, 2005

(54) Microphone output connector

(75) Inventor: Hiroshi Akino, Sagamihara-shi (JP)

Correspondence Address: WELSH & KATZ, LTD, 120 S RIVERSIDE PLAZA, 22ND FLOOR, CHICAGO, IL, 60606, US

(73) Assignee: Kabushiki Kaisha Audio-Technica, Tokyo (JP)

(21) Appl. No.: 10/929,620

(22) Filed: Aug. 26, 2004

(30) Foreign Application Priority Data
Sep. 19, 2003 (JP) 2003-327546

(51) Int. Cl. H01R 27/00

(52) U.S. Cl. 439/218

(57) ABSTRACT

A subject matter of this invention is to securely prevent high frequency electromagnetic waves which causes noise generation from entering to a microphone from a microphone output connector.

To achieve the subject matter, as shown in FIG. 1d, the microphone output connector includes a base 10 made of an electric insulator which is mounted at the rear end of a microphone grip of the capacitor microphone. The base 10 has an earth ground pin 23, a hot-side signal pin 21 and a cold-side signal pin 22 penetrating through the base. The earth ground pin 23 connects to the microphone grip (not shown) through a predetermined conductor. The microphone output connector is characterized in that at least an upper face 11a and a circumference 11b of the base are covered with an electromagnetic shield member 30 which is out of electrical contact with each of the signal pins 21, 22 and which is in electrical contact with the earth ground pin 23.

### FIELD OF THE INVENTION

The present invention relates to a capacitor microphone output connector. The invention especially relates to a technique preventing noise generation produced by high frequency electromagnetic waves generated by a cellular phone or the like.

### BACKGROUND OF THE INVENTION

Since an impedance of a capacitor microphone unit in a capacitor microphone is very high, the capacitor microphone includes an impedance converter such as a FET (Field Effect Transistor). A capacitor microphone generally uses a phantom power source and the microphone output signal is outputted through a balanced shield cable of the phantom power source.

For example, a hand-held microphone generally has a 3-pin output connector, and the microphone and the microphone cable are put on and taken off through the output connector. The 3-pin output connector is regulated in EIAJ (Electric Industries Association of Japan) Standards No. RC-5236, Title: “Circular connectors, latch lock type for audio equipment”. For example as shown in Japanese Patent Application Publication No. 11-341583, the connector includes a column-shaped base made of an electric insulator through which a No. 1 pin of the earth ground, a No. 2 pin of the hot-side signal and a No. 3 pin of the cold-side signal penetrate.

When an intense electromagnetic wave is applied to a microphone or a microphone cable, the electromagnetic wave enters into the microphone so that the electromagnetic wave may be outputted from the microphone as an audible noise modulated by an impedance converter. On the other hand, since an electrical connection of an output connector depends on a mechanical contact, the impedance of the mechanical contact which is especially given in a high frequency range will allow the electromagnetic wave to invade the microphone. This is another reason that the audible noise is generated.

As one of measures limiting the noise generated by the invasion of the electromagnetic wave, a capacitor which so works as to short the high frequency or an inductor which prevents the high frequency from invading the microphone is mounted in the vicinity of the 3-pin connector. As described in “Radio Frequency Susceptibility of Capacitor Microphones” (written by Jim Brown and David Josephson, published by AES Standard Committee in 2003), this way is sufficiently effective in general broadcast waves such as HF, VHF or UHF.

However, a chance that a higher frequency electromagnetic wave is applied to a microphone or a microphone cable has increased recently. Since the signal pins of the above-described 3-pin connector are not electrically shielded, a high frequency electromagnetic wave enters to the microphone and reaches an impedance converter of the microphone by radiation or propagation.

The No. 1 pin of the earth ground is grounded to a microphone case by a blade spring or a screw, however, the contact portion thereof has an impedance and the grounding state in a high frequency is insufficient so that even if a capacitor or a inductor for limiting the high frequency is mounted, no sufficient effect can be obtained.

### SUMMARY OF THE INVENTION

It is a subject matter of this invention is to securely prevent high frequency electromagnetic waves which cause noise generation from entering to a microphone from a microphone output connector.

To solve the above-described problems, the microphone output connector in this invention includes a base made of an electric insulator and mounted in the rear end of a microphone grip of the capacitor microphone. The base has a earth ground pin, a hot-side signal pin and a cold-side signal pin penetrating though the base, and the earth ground pin is connected to the microphone grip with a predetermined conductor. The microphone output connector is characterized in that at least an upper face and a circumference are covered with an electromagnetic shield member which is out of electrical contact with each of the signal pins and which is in electrical contact with the earth ground pin.

In another aspect, the electromagnetic shield member is a shield case having a base plate which covers on the upper face of the base and a skirt which covers the circumference of the base. The base plate has two through-holes (a first through-hole) for the signal pins and one through-hole (a second through-hole) for the earth ground pin. Each of the first through-holes does not electrically contact to the hot-side and the cold-side signal pins, and electrically contacts to the earth ground pin. The skirt is so formed as to electrically contact with the inner wall of the microphone grip.

As still another aspect, the invention includes the aspect that the electromagnetic shield member is a shield layer which is integrally evaporated or plated on the base.

As yet another aspect, each of the signal pins includes a high frequency noise filter, and preferably, the high frequency noise filter has a feedthrough capacitor.

According to this invention, since the upper face and the circumference of the base are covered with the electromagnetic member, even if the microphone is exposed to high frequency electromagnetic waves, the electromagnetic waves may not enter to the microphone. Therefore, the problems caused by the noise generation in the capacitor microphone having the impedance converter therein are solved.

### BRIEF DESCRIPTION OF THE DRAWINGS

FIGS. 1a, 1b, 1c and 1d, which show a microphone output connector regarding to the first embodiment of this invention, are, respectively, a plan view, a front view, a bottom view and a cross-sectional view of FIG. 1b taken along the line A-A.

FIGS. 2a, 2b, 2c and 2d, which show the microphone output connector regarding to the second embodiment of this invention, are, respectively, a plan view, a front view, a bottom view and a cross-sectional view of FIG. 2b taken along the line B-B.

FIGS. 3a and 3b, which show the microphone output connector regarding to the third embodiment of this invention, are, respectively, a front view and a cross-sectional view of FIG. 3a taken along the line C-C.

### DETAILED DESCRIPTION OF THE PREFERRED EMBODIMENTS

Referring to drawings some embodiments of the invention will be described, however, the invention is not restricted to these embodiments.

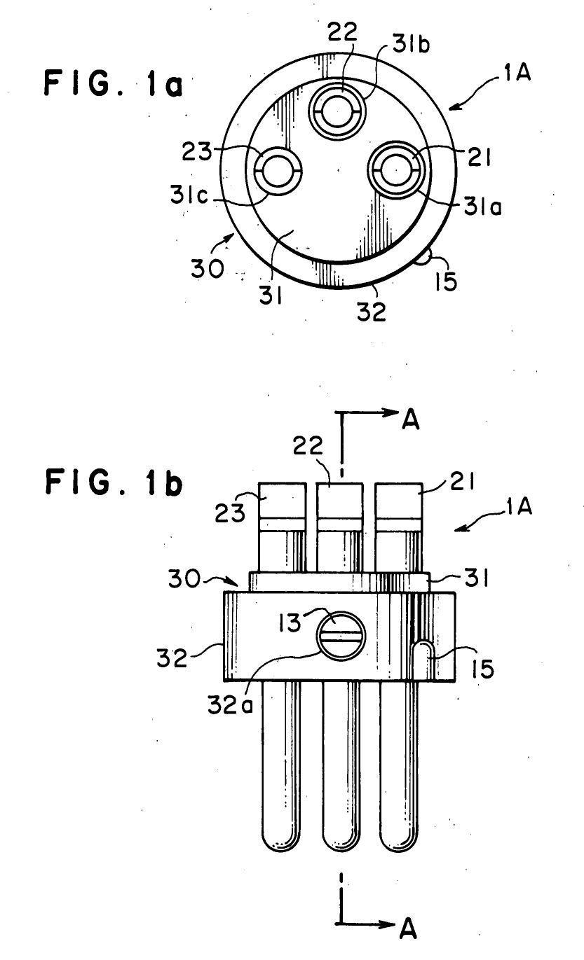

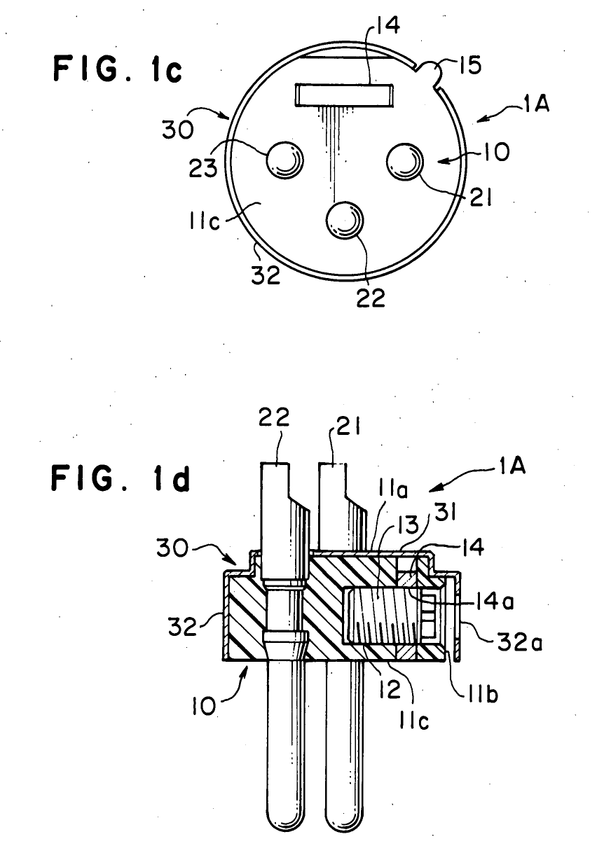

A microphone output connector 1A of the first embodiment of this invention will be described referring to FIGS. 1a, 1b, 1c and 1d which are, respectively, a plan view, a front view, a bottom view and a cross-sectional view of FIG. 1b taken along the line A-A. As a basic configuration of a capacitor microphone, the capacitor microphone has a microphone grip (a microphone case) in which a capacitor microphone unit and an impedance converter are included. The basic configuration of the invention is the same as that of a conventional capacitor microphone, so that the basic configuration is not shown in the drawings.

The microphone output connector 1A is a 3-pin connector regulated in EIAJ (Electric Industries Association of Japan) Standards No. RC-5236, Title: “Circular connectors, latch lock type for audio equipment”. The connector has a base 10 formed substantially in a columned shape.

The base 10 includes an upper face 11a which faces toward the inside of the microphone grip (not shown) and is placed in the grip in the manner that the base is mounted in the microphone grip. The base further includes a circumference 11b which faces to the inner wall of the grip and a bottom face 11c which faces toward the outside of the grip. A hot-side signal-pin 21, a cold-side signal-pin 22 and an earth ground pin 23 penetrate through the base 10 from the upper surface 11a to the bottom face 11c.

The base is made of an electric insulator, such as polybutylene teiphthalate (PBT) which is heat-resistant synthetic resin. It is preferable that each of the pins 21, 22 and 23 is integrally insert-molded in the base 10.

The base 10 is fixed to the rear end of the microphone grip by fixing means in this embodiment. As shown in the cross-sectional view of FIG. 1d, the circumference 11b of the base 10 has a screw housing hole 12 heading toward the center of the base to house a male screw 13 for fixing the base to the grip.

The screw housing hole 12 has no screw threads. A screw plate 14 which has a female screw hole 14a is vertically inserted to the screw housing hole 12 such that the male screw 13 screws together with the female screw hole 14a.

A screw driver is inserted through a hole 32a at the microphone grip side and the male screw 13 is turned by the driver and is moved toward the light direction in FIG. 1d, so that the microphone output connector 1A is fixed to the microphone grip with the male screw pushed to the inner wall of the microphone grip. The circumference 11b of the base 10 has a rib 15 engaged with a recess (not shown) which is formed in the microphone grip to prevent the base from circumferentially turning within the grip.

The microphone output connector includes a shield case 30 preventing electromagnetic waves produced outside of the microphone from invading the microphone. In this embodiment the shield case 30 includes a base plane 31 covering the upper face 11a of the base 10 and a skirt 32 covering the circumference 11b of the base 10. The shield case, as a whole, is made of a press-molded copper alloy, which is typical of brass. However, in this invention the material of the shield case is not restricted to copper alloy. Any material which can shield an electromagnetic wave can be used as the shield case 30.

Since the shield case 30 is covered on the upper face 11a, the base plane 31 has three through-holes 31a, 31b and 31c with these holes penetrating, respectively, for the pins 21, 22 and 23 through the base plane.

The diameters of the through-hole 31a of the hot side signal pin 21 and the through-hole 31b of the cold side signal pin 22 are lager than that of the pins such that the base plane dose not contact to the pins 21 and 22. However, it is preferable that the diameters of the through-holes 31a and 31b (first through-holes) are as small as they can to minimize the electromagnetic waves radiated into the inside of the microphone.

On the other hand, the diameter of the through-hole 31c (the second thiough-hole) of the earth ground pin 23 is smaller than that of the pin 23 and the pin 23 is tightly fit to the through-hole 31c such that the base plane can contact to the pin 23. However, as the other form, it is possible that when the diameter of the through-hole 31c is larger than that of the pin 23, the gap between the through-hole 31c and the pin 23 can be covered with soldering material.

The skirt 32 of the shield case 30 so formed as to contact to the inner wall of the microphone grip. It is preferable that the contact area between the skirt and the inner wall is as large as it can. As shown in FIGS. 1b and 1d, the shield case 30 has a hole 32a in the position where is correspondent to the screw housing hole 12. The diameter of the hole 32a is larger than that of the male screw 13.

Since the shield case 30 is covered on the microphone output connector 1A and electromagnetic waves are prevented from enter to the microphone, the noise generated by electromagnetic waves can be almost eliminated. A rear cover which is made of an electrostatic shielding material (not shown) is able to be covered on a bottom face 11c of the base 10. When the rear cover is used, the cover includes two non-contact through-holes, respectively, for the hot-side and the cold-side signal pins 21, 22, each of which has a larger diameter than that of the pins 21 or 22 as the base plane 31 does. The rear cover further includes one contact through-hole for the earth ground pin 23 which has a smaller diameter than the pin 23 does.

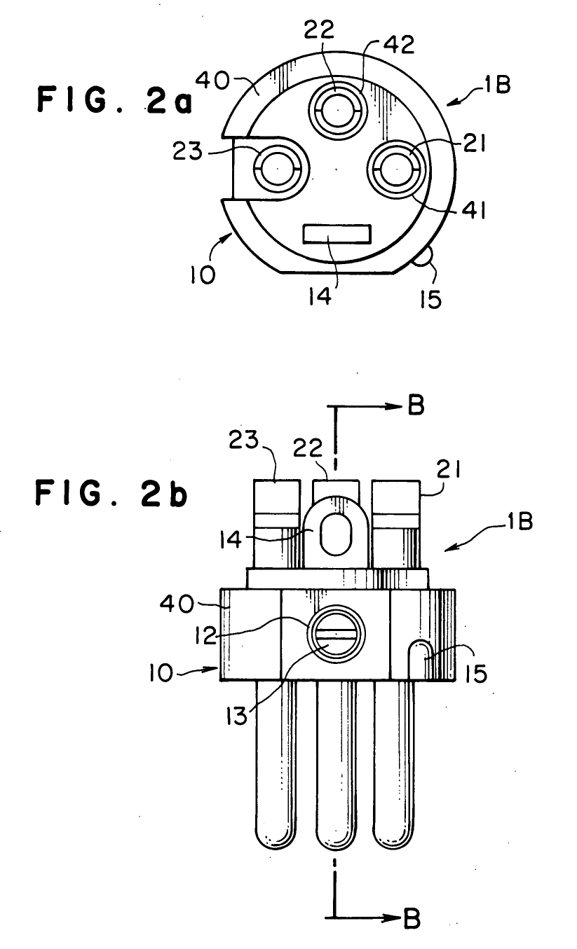

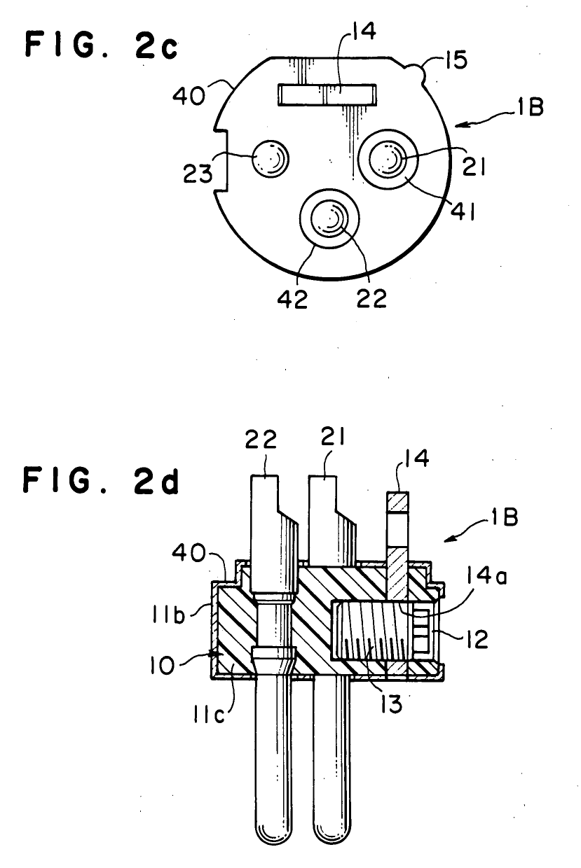

A microphone output connector 1B of the second embodiment of this invention will be described referring to FIGS. 2a, 2b, 2c and 2d which are, respectively, a plan view, a front view, a bottom view and a cross-sectional view of FIG. 1b taken along the line B-B. The same reference numerals and symbols will be assigned to the same components in FIGS. 2a to 2d as those in FIGS. 1a to 1d and the description will be omitted. In this second embodiment, the screw plate 14 protrudes over the upper face 11a of the base 10 as an earth terminal.

In the second embodiment, a shield layer 40 is formed to prevent electrostatic waves produced outside of the microphone from invading the microphone in place of the shield case in the first embodiment. The shield layer 40 can be formed by evaporating or plating. Copper alloy such as brass, which is used as the shield case 30, is preferably employed as the shield layer 40.

In this example the shield layer 40 is formed on the whole faces of the base 10, that is, on the upper face 11a, on the circumference 11b and on the bottom face 11c. Non-shield areas 41 and 42 which do not have the shield layer, respectively, around the hot-side and the cold-side signal pins 21 and 22 are so disposed as not to contact the layer 40 to pins 21 and 22.

On the other hand the shield layer 40 is so formed as to contact to the earth ground pin 23. When each of the pins 21, 22 and 23 is insert-molded, the shield layer 40 is formed by evaporating or plating after masks (not shown) are covered on the hot-side and the cold-side pins 21, 22. In order to obtain a good contact between the earth ground pin 23 and the shield layer 40, it is preferable that the shield layer 40 is formed on the base 10 including the inside of an inserted hole for the pin 23 in the base 10, and then the pin 23 is inserted to the inserted hole.

The shield layer 40 is so formed as to contact to the screw plate 14. As shown in FIG. 7 in Japanese Patent Application Publication No. 11-341583, the screw plate 14 and the earth ground pin 23 are generally connected with a specific connecting metal. According to this second embodiment, no connecting metal needs since the screw plate 14 electrically connects to the earth ground pin 23 through the shield layer 40. The shield layer 40 on the bottom face 11c can be omitted.

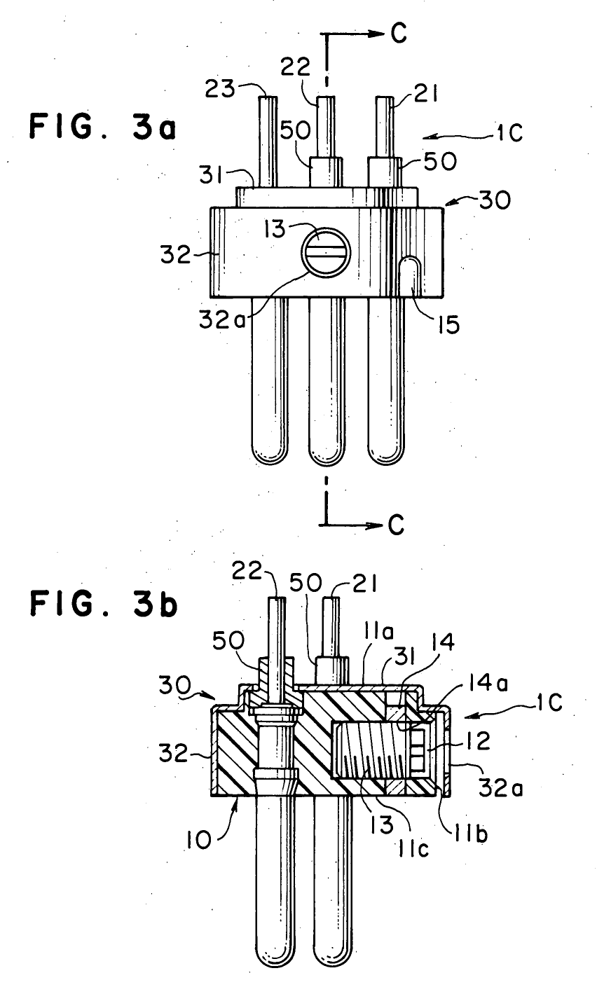

A microphone output connector 1C of the third embodiment of this invention will be described referring to FIG. 3a which is a front view and FIG. 3b which is a cross-sectional view of FIG. 3a taken along the line C-C.

The output connector 1C further includes high frequency noise filters for more-effectively preventing electromagnetic waves from invading the microphone. In the embodiment having the same structure including the shield case 30 as the first embodiment dose, each of the hot-side and the cold-side signal pins 21 and 22 includes a feedthiough capacitor 50 in the high frequency noise filter. This aspect can be applied to the structure having the shield layer 40 of the second embodiment.

According to the invention, in the capacitor microphone having the impedance converter, electromagnetic waves invading the microphone can be prevented by a relatively simple structure. The capacitor microphone having a low cost, a low noise and a high performance can be provided.

1. A microphone output connector includes a base mounted in the rear end of a microphone grip, the base being made of an electric insulator and having an earth ground pin, a hot-side signal pin and a cold-side signal pin penetrating through the base, the earth ground pin connected to the microphone grip with a predetermined conductor, the microphone output connector comprising:
an electromagnetic shield member covering at least an upper face and a circumference of the base; and
wherein the electromagnetic shield member does not electrically contact to the hot-side and the cold-side signal pins and electrically contacts to the earth ground pin.

2. A microphone output connector according to claim 1, wherein the electromagnetic member is a shield case having a base plate which covers the upper face of the base and a skirt which covers the circumference of the base, the base plate having two of first through-holes for the hot-side and the cold-side signal pins and one of a second through-hole for the earth ground pin penetrating through the base, each of the first through-holes being out of electrical contact with the hot-side and the cold-side signal pins, the second through-hole being in electrical contact with the earth ground pin, the skirt electrically contacting to the inner wall of the microphone grip.

3. A microphone output connector according to claim 1, wherein the electromagnetic member is a shield layer which is integrally evaporated or metal-plated on the base, the shield layer being in electrical contact with the earth ground pin and being out of electrical contact with the hot-side and the cold-side signal pins.

4. A microphone output connector according to claim 1, wherein each of the hot-side and the cold-side signal pins has a high frequency noise filter.

5. A microphone output connector according to claim 4, wherein the high frequency noise filter includes a feedthrough capacitor.
